(19) United States
(12) Patent Application Publication
(10) Pub. No.: US 2008/0238608 A1
(43) Pub. Date: Oct. 2, 2008

(54) ANTI-THEFT SYSTEM AND METHOD

(75) Inventor: Steven W. GOLDSTEIN, Delray Beach, FL (US)

Correspondence Address: GREENBERG TRAURIG, LLP, 2101 L Street, N.W., Suite 1000, Washington, DC, 20037, US

(73) Assignee: Personics Holdings Inc., Boca Raton, FL (US)

(21) Appl. No.: 11/833,026

(22) Filed: Aug. 2, 2007

Related U.S. Application Data
(60) Provisional application No. 60/821,253, filed on Aug. 2, 2006.

(51) Int. Cl. G06F 7/04; H04L 9/32

(52) U.S. Cl. 340/5.2

(57) ABSTRACT

At least one exemplary embodiment is directed to an anti-theft method comprising: determining whether a user's authorization parameters match stored verification parameters; selecting a feature of a device to affect if the user's authorization parameters do not match the stored verification parameters; and gradually affecting the selected feature of the device.

### CROSS-REFERENCE TO RELATED APPLICATIONS

This application claims the benefit of U.S. provisional patent application No. 60/821,253 filed on 2 Aug. 2006. The disclosure of which is incorporated herein by reference in its entirety.

### FIELD OF THE INVENTION

The present invention relates to an anti-theft method and system for electronic devices, and in particular is directed, though not exclusively, to anti-theft systems that shut off or gradual degrade performance of electronic instruments when used by a non-authorized user.

### BACKGROUND OF THE INVENTION

Despite the best efforts of law enforcement authorities, larceny and theft are problems in nearly every part of the world. In the United States alone, property thefts exceed billions of dollars each year. Portable consumer electronics are a common target for theft. A laptop computer is stolen every 53 seconds and only a small percentage are ever recovered (Safeware Insurance Agency, 2004). Smaller portable consumer electronics such as personal music players, portable video players, video recorders, portable gaming systems, digital cameras, and headphone systems are also frequently lost or stolen.

Currently, there exist a variety of anti-theft devices that are associated with consumer electronics devices and other appliances. For example, software solutions exist for the recovery of stolen personal computers. The physical location of a personal computer reported as lost or stolen is tracked whenever the computer is connected to the Internet. However, these solutions are only effective when the personal computer is connected to the Internet and these solutions are not always practical for smaller, portable appliances.

Recent advances in wireless communication protocols provide a variety of options for implementing the communications port in the present invention. The purpose of the communications port is to allow a central server system to remotely interface with the Target Appliance. Additionally the Bluetooth wireless communications protocol (IEEE 802.15) is widely implemented and allows for very low-power operation (less than 1 mW).

Open Wi-Fi (IEEE 802.11) wireless networks are increasingly common. Wi-Fi generally has higher power requirements than Bluetooth, but also an increased range and higher data rates. However, the coverage area is still limited.

RFID tags can operate with very low power or even no power (passive RFID tags). The range of an RFID tag, which is directly related to power consumption, can be significant. However, a high power reader and a low power or even passive tag can still have a significant range.

In many parts of the world, cellular networks have become nearly ubiquitous. The coverage area for cellular networks is huge. A variety of protocols are used in cellular networks, but perhaps the most common is code division multiple access (CDMA).

The universal serial bus (USB) standard is a wired communications protocol that is nearly ubiquitous in the consumer electronics industry. It is an asymmetric interface that allows a host (usually a personal computer) to communicate with various devices (digital cameras, external storage devices, personal music players, etc). Additionally, USB technology is capable of supplying power to these devices. It should be noted that a wireless USB protocol has recently been standardized, but it is not as widely implemented as wired USB.

Presently, property recovery systems rely heavily on law enforcement. Despite noble intent, law enforcement agencies can be slow and unreliable. Additionally, a consumers prefer to avoid involving law enforcement in their personal affairs.

Conventional systems, which completely disable missing or stolen Target Appliances instead of interfering with Target Appliance operation, have been purposed (Stephen-Daly, U.S. Pat. No. 7,046,144). Completely disabling the appliance, by disabling the power supply for example, can provide an effective deterrent but this approach makes electronically tracking the physical location of the appliance significantly more difficult.

The digital storage capacity for portable electronic devices has become significant. Personal music players, video players, digital cameras, portable gaming systems, and other appliances have increasingly large storage capacities.

Conventional system discuss the use of a password that is transmitted to remotely disable Target Appliances (Valiulis, U.S. Pat. No. 6,317,028, Chou, U.S. Pat. No. 5,892,906). Generally, the end-user registers Target Appliances, specifying a device password for each Target Appliance. For Target Appliances that interface with a personal computer during normal operation, the user is also asked for the MAC (media access control) addresses of a computers the Target Appliance will regularly interface with.

Requests for the device password can be triggered by a variety of scenarios. For example, if the Target Appliance interfaces with a computer that has an unrecognized MAC address, the device password is requested either through the personal computer or by the Target Appliance itself.

### SUMMARY OF THE INVENTION

At least one exemplary embodiment of the present invention is directed to deterring thefts and encourage the return of missing or stolen appliances by providing a method for the end-user to both initiate interference with the operation of a missing or stolen Target Appliance, and also convey a warning message to the individual in possession of the Target Appliance. In another iteration, the Target Appliance itself can attempt to enable its own anti-theft deterrent system. Further exemplary embodiments disclose tracking the approximate physical location of the appliance.

At least one exemplary embodiment of the present invention is directed to a solution that can be applied to a of the smallest portable appliances such as personal music players, portable video players, portable gaming systems, digital cameras, video recorders and headphone systems.

Almost a communications system known to one of ordinary skill in the relevant art, standard or proprietary, can be used to implement at least one exemplary embodiment of the present invention, but the coverage area of the chosen protocol will have a direct relationship to the effectiveness of the anti-theft system. However, because ma portable devices interface with a personal computer as part of their regular operation, a short-range wireless protocol or even a wired protocol can still be effective. Using the personal computer as an intermediate, the target portable appliance can interface with the central server system through an Internet connection. Additionally, utilizing low-power Bluetooth protocols, exemplary embodiments of the present invention can be applied to even the smallest Target Appliances. However, the Bluetooth protocol can be used to interface with an intermediate device, such as a personal computer, that can then connect to the central server system through another communications network, such as the Internet.

Global positioning systems (GPS) provide extensive coverage areas, low-power implementations, and accurate tracking, and can be used with locating a stolen article in accordance with at least one exemplary embodiment.

Radio Frequency Identification (RFID) is a maturing wireless technology that can be used in at least one exemplary embodiment of the present invention. An anti-theft system according to at least one exemplary embodiment, utilizing RFID technology can implement both remotely triggered interference of appliance operation and physical location tracking. This makes RFID an appealing choice for implementing exemplary embodiments of the present invention.

At least one exemplary embodiment can use the CDMA protocol because it is low power, long range, and widely implemented. Also, CDMA requires each transceiver device to have a unique pseudo-noise code, which can double as an identification code for the anti-theft system. An anti-theft system utilizing cellular networks can implement both remotely triggered interference of appliance operation and physical location tracking. This makes cellular communication networks one of the more appealing choices for implementing at least one exemplary embodiment of the present invention.

At least one exemplary embodiment of the present invention is related to a secure website interface as well as a telephone hotline, allowing the end-user to register targeted appliances and then compromise operations of missing or stolen appliances remotely by simply supplying login information. Although recovery would generally require the involvement of law enforcement authorities, the end-user can interfere with Target Appliance operation without contacting the police. At least one exemplary embodiment of the present invention can optionally transmit a report to law enforcement agencies. The user's preferences regarding the involvement of various authorities can be entered during the registration process or during the missing or stolen appliance reporting process. By interfering with appliance operation, at least one exemplary embodiment of the present invention allows for electronic location tracking and then some. Furthermore, since the power has not been disabled for the Target Appliance, a warning message can be conveyed to the individual in possession of the stolen appliance. The message can include information for returning the appliance anonymously a associated rewards.

Therefore, for example one purpose of interfering with appliance operation is not to completely disable a missing or stolen appliance, but to introduce an Annoyance factor that makes the appliance far less usable, and less enjoyable. Methods for interfering with the operation of Target Appliances are almost as numerous and varied as the appliances themselves. Due to the popularity of personal music players and related consumer electronics, methods for interfering with audio playback are disclosed in the embodiments within. These methods include introducing a warble tone, introducing intermittent annoyance signals, introducing a spoken warning message indicating the unit has been reported stolen or is in the an unauthorized state, and muting audio playback. In at least one exemplary embodiment the above listed methods can also be adapted to video recording or playback. For example, distortion can be introduced into the video signal, a warning message can be displayed, and video playback can be blacked out. These methods can be applied to portable video recorders, video players, digital cameras, portable gaming systems, or a appliance that includes a video display.

At least one exemplary embodiment of the present invention utilizes a very small amount of the Target Appliance storage space for storing registration information such as device passwords, a list or recognized MAC addresses, and other related information. Appliance storage capacity also is related to another opportunity for Target Appliance operation interference.

At least one exemplary embodiment fills the storage system of the Target. Appliance with dummy data, operational interference has been achieved, especially for appliances without removable storage. Restricting or completely denying access to the storage system of the Target Appliance can maintain operational interference, even for appliances with removable storage. Also, for appliances that capture content like digital cameras or digital voice recorders, captured content can be distorted when it written to the storage system, providing another method for appliance interference. For example, the storage system on a digital camera can be made out of focus or whereby the data storage memory indicates full all the time.

A portable appliances are capable of running third party software or even alternative operating systems. One prominent example is the Apple iPod, which is capable of running a port of the Linux operating system. Provided appliance support, an application implementing various features of at least one exemplary embodiment of the present invention can be included in an appliance's storage system. This type of implementation allows for the anti-theft system to be downloaded (doped) after the user purchased the Target Appliance, thus not requiring the collaboration of the manufacturer, which can prove to be a very inefficient process.

In at least one exemplary embodiment the present invention uses a secure transmission or a trigger signal to initiate Target Appliance operation interference remotely. Exemplary embodiments can also use a password system for alternative uses. A device password, which is specified by the end-user, is associated with every Target Appliance. When a certain set of criteria is met, a request for the device password is generated. The end-user can supply the device password correctly or the operation of the target device is interfered with. In at least one exemplary embodiment, the registration process involves the end-user accessing the central server system through a user interface. However, in other exemplary embodiments the central server system is extraneous because the device password and a list of recognized MAC addresses are setup by the end-user in the appliance locally. Thus, the device password system can either be self-contained and local to the Target Appliance, or distributed between the Target Appliance and the central server system.

For Target Appliances that do not necessarily interface with a personal computer, requests for the device password can also be triggered at regular time intervals or even random time intervals by the Target Appliance's internal clock. Alternatively, device password request intervals can relate to the number of times the Target Appliance's power supply has been recharged.

Again, for appliances that regularly interface with a personal computer, a more intelligent approach can be implemented. Ma such appliances can recharge their power supply using the interface with the personal computer (i.e. USB device). However, these devices can also recharge using a converter and an AC adapter. In at least one exemplary embodiment of the present invention, after a certain number of Target Appliance recharge sessions using an AC adapter instead of a personal computer connection, a device password request is generated. When the Target Appliance is interfacing with a personal computer that has a recognized MAC address, this generally indicates the appliance is not missing or stolen and there is no need to generate a device password request.

Further areas of applicability of exemplary embodiments of the present invention will become apparent from the detailed description provided hereinafter. It should be understood that the detailed description and specific examples, while indicating exemplary embodiments of the invention, are intended for purposes of illustration only and are not intended to limited the scope of the invention.

### BRIEF DESCRIPTION OF THE DRAWINGS

Exemplary embodiments of present invention will become more fully understood from the detailed description and the accompanying drawings, wherein:

FIG. 1 illustrates an illustration of an example of at lest one exemplary embodiment that can physically reside in a target device; and

FIG. 2 illustrates an illustration of the central server system in accordance with at least one exemplary embodiment.

### DETAILED DESCRIPTION OF EXEMPLARY EMBODIMENTS OF THE PRESENT INVENTION

The following description of exemplary embodiment(s) is merely illustrative in nature and is in no way intended to limit the invention, its application, or uses.

Exemplary embodiments are directed to or can be operatively used on various wired or wireless earpieces devices (e.g., earbuds, headphones, ear terminals, behind the ear devices or other acoustic devices as known by one of ordinary skill, and equivalents).

Processes, techniques, apparatus, and materials as known by one of ordinary skill in the art may not be discussed in detail but are intended to be part of the enabling description where appropriate. For example specific computer code can not be listed for achieving each of the steps discussed, however one of ordinary skill would be able, without undo experimentation, to write such code given the enabling disclosure herein. Such code is intended to fall within the scope of at least one exemplary embodiment.

Additionally exemplary embodiments are not limited to earpieces, for example a functionality can be implemented on other systems with speakers and/or microphones for example computer systems, PDAs, Blackberrys, cell and mobile phones, and a other device that emits or measures acoustic energy. Additionally, exemplary embodiments can be used with digital and non-digital acoustic systems. Additionally various receivers and microphones can be used, for example MEMs transducers, diaphragm transducers, for examples Knowle's FG and EG series transducers.

Notice that similar reference numerals and letters refer to similar items in the following figures, and thus once an item is defined in one figure, it can not be discussed or further defined in the following figures.

### SUMMARY OF EXEMPLARY EMBODIMENTS

At least one exemplary embodiment of the present invention can comprise: a Target Appliance Component and an optional central server system. The central server system is not required if the Target Appliance Component is installed during the manufacturing of the Target Appliance, or if the Target Appliance Component is installed by the end-user through a local interface (i.e. an installation disc running on the end-user's personal computer interfacing with the Target Appliance).

The Target Appliance Component system can reside inside the Target Appliance as part of the device storage system, or as an additional hardware component inside the appliance, or a combination of both. The Target Appliance Component further comprises a communications port, an Annoyance mechanism, and an encrypted or hidden digital file on the appliances storage system. The storage system contains data relating to exemplary embodiments of the present invention including the device password, a list of recognized MAC addresses, a application data supporting communications or the annoyance mechanism, and other related data.

The communications port implements a communications protocol, as described in the background of the invention. This communications protocol can be wired or wireless, standard or proprietary. Almost a communications protocol can be applied, given the protocol enables at least intermittent communications between the Target Appliance and the central server system either directly or through an intermediate, such as a personal computer connected to the Internet. If present, a communications port implemented by the Target Appliance as part of its normal functionality can be used, or a separate communications port can be implemented by adding additional hardware.

The Annoyance mechanism, which is also resident in the Target Appliance, implements a method for interfering with the operation of the Target Appliance upon activation. The method of interference is dependant on the type of Target Appliance. In a Target Appliance for audio playback, such as a personal music player or an advanced headphone system, the Annoyance mechanism can implement a method for interfering with audio playback. By example, these methods include introducing a warble tone, introducing intermittent annoyance signals, introducing a spoken warning message indicating the appliance has been reported missing, and muting audio playback.

Similarly, in an appliance for video playback the Annoyance mechanism can implement a method for interfering with video playback. By example, these methods include introducing distortion into the video signal, introducing intermittent annoyance frames into the video signal, displaying a warning message indicating the appliance has been reported missing, and blacking out video playback.

In an appliance that writes digital content to a storage system, the annoyance mechanism can interfere with the writing of the digital content. By filling the storage system of the Target Appliance with dummy data, operational interference has been achieved, especially for appliances without removable storage. Restricting or completely denying access to the storage system of the Target Appliance can maintain operational interference, even for appliances with removable storage. Also, for appliances that capture content like digital cameras or digital voice recorders, captured content can be distorted when it written to the storage system, providing another method for appliance interference. For example, the auto-focus on a digital camera can be made out of focus or out of focus intermittently.

The annoyance mechanism can take the form of an application executed on the Target Appliance. Through the communications port, the annoyance mechanism can be triggered remotely from the central server system. For example, when the end-user reports a Target Appliance as missing or stolen, the central server system transmits a trigger signal to the Target Appliance that initiates the Annoyance mechanism.

Alternatively, for appliances that interface with a personal computer during normal operation, the Annoyance mechanism can be triggered locally. This is accomplished by storing a device password and a list of recognized MAC addresses in the encrypted/hidden storage system of the Target Appliance Component. Every time the device interfaces with a personal computer, the MAC address of the personal computer is checked against the stored list of recognized MAC addresses. This list of recognized MAC addresses is entered by the end-user during a registration or setup process. If the current MAC address is not listed, a request for the device password is generated. The password request is displayed either on the personal computer or on the appliance itself. The annoyance mechanism is triggered unless the device password is entered correctly.

Ma appliances that interface with a personal computer can recharge their power supply using the same connection (i.e. USB devices). However, these appliances can also recharge using a converter and an AC adapter. After a certain number of appliance recharge sessions using an AC adapter instead of a personal computer connection, a device password request is automatically generated. The condition where the Target Appliance is interfacing with a personal computer that has a recognized MAC address generally indicates the appliance is not missing or stolen. Therefore this condition mitigates the device password request.

The device password system can be applied to appliances that do not interface with a personal computer as well. For such appliances, the device password can be requested at regular time intervals or even randomly spaced time intervals. Also, device password requests can correspond to the recharging of the Target Appliance. For example, every fifth time the Target Appliance is recharged; a device password request is generated.

In further exemplary embodiments, the Target Appliance Component also contains a physical and/or electronic Badge. The Badge indicates the Target Appliance in accordance with at least one exemplary embodiment of the present invention and is related to an additional theft deterrent. The Badge can take the form of a physical label affixed to the Target Appliance, an electronic image displayed by the Target Appliance, or even an audible sound generated by the Target Appliance.

Although at least one exemplary embodiment of the present invention can be implemented using only the Target Appliance Component, the central server system compliments the Target Appliance Component by supporting a variety of processes that enhance the anti-theft system. The central server system supports a user interface system, the Target Appliance registration process, the device password system, the missing or stolen Target Appliance reporting process, and communications with a plurality of Target Appliance Components.

The user interface system comprises of two primary interface methods: a website interface and a telephone hotline interface. This allows the end-user to access the processes supported by the central server system either through a web browser or through a phone call. The website interface includes various security feature familiar to those skilled in the art. The telephone hotline interface can use a call center, an automated system, or a combination of both.

Through the user interface the end-user can access the Target Appliance registration process, which allows the user to setup the anti-theft system. Pertinent information is solicited from the end-user during the registration process, including user name, login information, Target Appliance make/model, bill-of-sale information, payment information, various preferences, and other data. For the case where the device password system is distributed between the Target Appliance Component and the central server system, the registration process also is related to access to the device password system. The end-user is asked to provide an appropriate device password and, when appropriate, a list of recognized personal computers and their MAC addresses. The central server system maintains a detailed record of a plurality of users, device passwords, and the associated MAC addresses.

The missing or stolen Target Appliance reporting process is supported by the central server system and is also accessed through the user interface system. A verification process, requiring the user to submit login information from the registration process, can be used to verify the identity or the user. After verification, the user specifies which registered Target Appliance is missing or stolen (one user can register several Target Appliances). Other information can also be solicited at this time including the circumstances of the loss or theft and the user's preferences regarding the involvement of various authorities. Once the necessary information has been collected, a signal is transmitted from the central server system, through the communications network, to the communications port of the Target; Appliance Component. This signal triggers the annoyance mechanism. The signal can also contain additional information. For example, the signal can contain information specifying the details of the warning message generated by the annoyance mechanism.

### Sample Terminology

The following terminology presents examples only of meanings of commonly used terminology and is intended to aid in the understanding of exemplary embodiments, and is not meant to be limitative in nature.

Appliance: “Appliance” refers to a manufactured electronic device.

Annoyance: “Annoyance” refers to a condition or aberration that interferes with the normal operation of a Target Appliance.

Badge: A “Badge” refers to a physical or electronic apparatus for conveying the brand or manufacturer associated with a particular Appliance. A Badge can also indicate the presence of an anti-theft device in a particular Appliance.

Communications: “Communications” refers to a method for transmitting data.

Personal Media Player: “Personal Media Player” refers to a portable Appliance with a pocket size form factor that implements a technology for digital media playback.

Target Appliance: “Target Appliance” refers to an Appliance to which exemplary embodiments of the present invention can be applied.

Target Appliance Component: “Target Appliance Component” refers to the software, hardware, or firmware making up at least a portion of at least one exemplary embodiment of the present invention that can be resident in the Target Appliance.

### DETAILED DESCRIPTION OF EXEMPLARY EMBODIMENTS

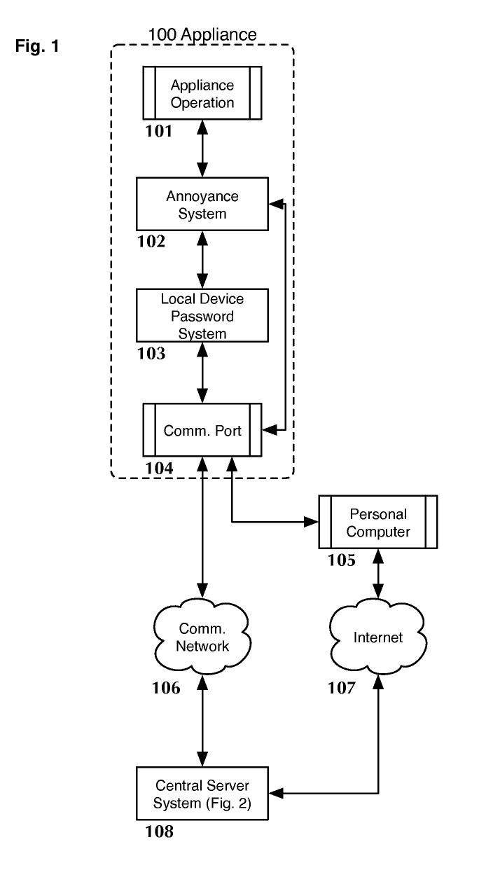

FIG. 1 illustrates a high-level illustration of the Target Appliance Component of at least one exemplary embodiment of the present invention. All of these systems can physically reside in the Target Appliance with the exception of the Communications network [105] and the central server system [106]. Note that these systems can exist as software or firmware on a storage system already implemented by the Target Appliance as part of normal functionality. Alternatively, these systems can exist as additional hardware included in the Target Device during the manufacturing process or a combination of software, firmware, and hardware.

The Annoyance System [102] implements a method for interfering with the normal Appliance Operation [101] of the Target Appliance. For example the volume can gradually decrease, lights can flash on the screen, the screen can gradually get dimmer, beeps can sound in at more and more frequent intervals. In at least one exemplary embodiment, the interference method of the Annoyance System [102] is triggered when a set of locally stored criteria for Appliance Operation [101] are met. These criteria indicate the Target Appliance might be missing or stolen and are stored as part of the Annoyance System [102]. Therefore the Annoyance System [102] also monitors normal Appliance Operation [101] to see if and when these criteria are met.

In further exemplary embodiments, the operation interference method of the Annoyance System [102] can be triggered by a trigger signal received through the Communications Port [104]. The trigger signal can be generated at the Central Server System [108] and transmitted across a Communications Network [106] to the Communications Port [104]. Alternatively, the Communications Port [104] can interface with a Personal Computer [105] that communicates with the Central Server System [108] over the Internet [107], thus transmitting the trigger signal to the Target Appliance through an intermediate.

Similarly, the operation interference method of the Annoyance System [102] can be deactivated by a signal received through the Communications Port [104]. Again this can be achieved either by direct communication with the Central Server System [108] over a Communications Network [106], or by communication with the Central Server System [108] through an intermediate consisting of a Personal Computer [105] and the Internet [107].

In further exemplary embodiments, the operation interference method of the Annoyance System [102] can be deactivated locally by the Local Device Password System [103]. This can be achieved by correctly entering the device password through a local interface system connected to the Local Device Password System [103]. The Local Device Password System [103] can be either setup locally during an initialization process or setup during a Target Appliance registration process through the Central Server System [108].

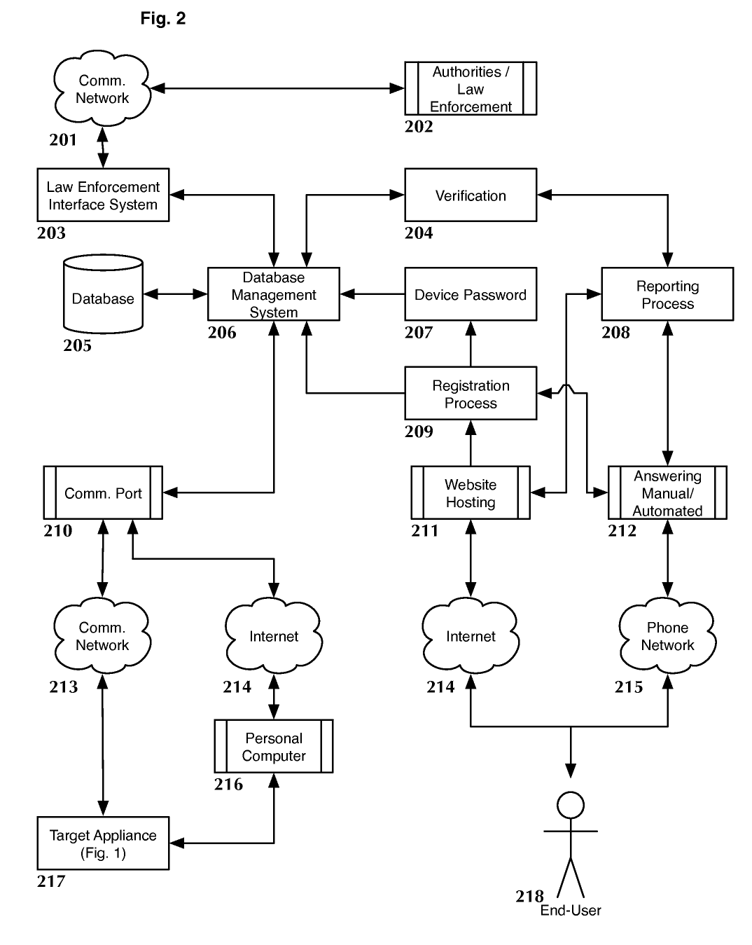

FIG. 2 illustrates an illustration of the Central Server System for supporting at least one exemplary embodiment of the present invention. Again, the Target Appliance Component [217] interfaces with the Communications Port [210] of the Central Server System either by direct communication over a Communications Network [213], or by communication through an intermediate system consisting of a Personal Computer [216] and the Internet [214].

The Communications Port [210] interfaces with the Database Management System [206] of the Central Server System, where the operation interference trigger signals are generated. The trigger signals are generated after the End-User [218] reports the Target Appliance as missing or stolen through the Reporting Process [208] and successfully completes the Identity Verification Process [204].

The End-User [218] uses one of two interfaces to communicate directly with the Central Server System. The End-User [218] can interface with a Website [211] over the Internet [214] or a Manual/Automated Answering System [212] over a Telephone Network [215].

Either interface allows the End-User [218] to access both the Reporting Process [208] and the Registration Process [209]. During the Registration Process [207], the End-User [218] supplies personal information and creates a Device Password [207], both of which can be sent to the Database Management System [206] for storage in the Database System [205].

The Law Enforcement Authorities Interface System [203] communicates with the Database Management System [206] to provide Law Enforcement Authorities [202] appropriate access to information stored in the Database System [205]. Law Enforcement Authorities [202] can utilize the Law Enforcement Authorities Interface System [203] across a Communications Network [201], which can be a private network or a public network like the Internet.

### Further Exemplary Embodiments

An anti-theft system for Appliances enabling operational interference by introducing Annoyance, the system comprising: a Target Appliance Component resident in the Target Appliance, either: in the storage system of the Appliance (i.e. in the memory of a Personal Media Player) or; in hardware components, such as integrated circuits, installed during the manufacture of the Target Appliance, or; a combination of the above.

The Target Appliance Component system further comprising: an encrypted or hidden storage system for storing data related to at least one exemplary embodiment of the present invention including device passwords, recognized MAC addresses, user information, device information, warning messages, and related data; an Annoyance system for interfering with the operation of the Target Appliance; and a local device password system for managing an alphanumeric device password associated with the Target Appliance.

The Annoyance system of at least one exemplary embodiment, where the Annoyance system limits the operation (e.g., maximum volume, screen illumination, data transfer rate, or any other feature that can be controlled as understood by one of ordinary skill in the relevant arts) of the Target Appliance making the Appliance significantly less usable, the system further comprising a combination of the following: a method for interfering with the operation of the Target Appliance by introducing an Annoyance factor; a method for triggering Appliance operational interference based on trigger signals received through the Communications system of embodiment; the trigger signals can be sent from the central server system of embodiment when a verified end-user reports the Target Appliance as missing or stolen; a method for triggering Appliance operational interference based on a set of criteria stored locally in the storage system of at least one exemplary embodiment, where, the criteria can relate to a combination of the following: the number of power supply recharging sessions for the Target Appliance; a regular time interval; a random time interval; the MAC address of a personal computer the Target Appliance interfaces with and a stored list of recognized MAC addresses; the number of consecutive power supply recharging sessions before the Target Appliance interfaces with a personal computer or a other intermediate system; and a pairing with a new device through the Communications port, if supported by the Communications protocol.

At least one method in accordance with the exemplary embodiment is directed to deactivating Appliance operational interference based on trigger signals received through the Communications system of embodiment; and the trigger signals can be sent from the central server system of embodiment, when a verified end-user reports the missing or stolen Target Appliance as recovered.

At least one method in accordance with the exemplary embodiment is directed to deactivating Appliance operational interference when the correct alphanumeric device password is supplied through the local device password system of at least one exemplary embodiment.

The local device password system according to at least one exemplary embodiment, where the local device password system allows the end-user to locally deactivate the Annoyance system by correctly entering the device password using a local interface, restoring normal operation of the Target Appliance, the system further comprising: a local interface system for the end-user to enter the device password and related information into the Target Appliance Component system, where the interface system comprising a combination of the following: the local interface system of the Target Appliance that is implemented as part of the device's normal functionality; if the interface does not inherently support entering of alpha-numeric characters, the functionality of the interface can be adapted by the local device password system to allow the end-user to enter a device password; where the interface system of a personal computer that can be connected with the Target Appliance through the Communications port.

At least one exemplary embodiment includes a password setup method, wherein the device password setup method comprises a of the following: a local device password setup process allowing the end-user to specify a alphanumeric device password for the target device through the local interface system; for security, this process can only be accessed once, during the initialization of the target device by the end-user; a device password setup process accessed through the registration process of the central server system of embodiment, allowing the end-user to specify a alphanumeric device password for the target device; the device password can be stored both in the local device password system and the database system of the central server; and where after successfully completing a verification process, the end-user can reset the device password through the central server system.

The method according to at least one exemplary embodiment wherein the method for interfering with the operation of the Target Appliance further comprising a combination of the following: a method for interfering with audio playback by introducing a Annoyance factor which can include a combination of the following: a warble tone introduced over the audio playback; an intermittent audio signal introduced into the audio playback; a spoken warning message introduced into the audio playback; the spoken warning message can include details relating to the anonymous return of the Target Appliance; muting all audio playback; forcing audio playback at full volume; and oscillating the volume of audio playback or randomly changing the volume of audio playback.

A method of at least one exemplary embodiment that interferes with video playback by introducing a Annoyance factor which can include a combination of the following: a distortion introduced to the video signal; an intermittent noise video signal introduced into the video playback; blacking out video playback; and an inappropriate frame rate resulting in video playback that is too fast or too slow.

A method in accordance with at least one exemplary embodiment that interferes with reading or writing of data to the storage system of the Target Appliance, which can include a combination of the following: Denying read access to the storage system; denying write access to the storage system; manipulating the content read from the storage system such that it can be diminished or unintelligible; manipulating the content read from the storage system such that the content can be diminished or unintelligible; and manipulating the content written to the storage system such that the content can be diminished or unintelligible (i.e. distorting the images captured by a digital camera).

In accordance with at least one exemplary a warning message can be conveyed through the Target Appliance as part of the Annoyance system, the method comprising: a warning message that conveys a combination of the following: a message indicating the Target Appliance has been reported as missing or stolen; a message indicating the Target Appliance has been subjected to a set of criteria that has triggered the Annoyance mechanism locally and the device password can be entered correctly; directions relating to the process of entering the device password; Information relating to the anonymous return of the Target Appliance; and information relating to a compensation associated with the return of the Target Appliance.

At least one exemplary embodiment is directed to a method for conveying the warning message through the Target Appliance, which can take the form of a combination of the following: a speech signal introduced into the audio playback of the Target Appliance either intermittently or in continuous loop; a set of text presented on the display of the target device either intermittently or continuously; and a video signal presented on the display of the target device either intermittently or continuously.

At least one exemplary embodiment includes a method allowing the end-user to specify a warning message through a combination of the following: a local Target Appliance setup process that occurs immediately after the device password setup process of at least one exemplary embodiment; the central server system of embodiment; a method for storing the warning message locally in the target device; and a method for receiving the warning message or a part of the warning message through the Communications port.

At least one exemplary embodiment includes a Badge system is included to identify the Target Appliance as being protected by at least one exemplary embodiment of the present invention, the Badge system further comprising a combination of the following: a physical marking visible on the Target Appliance indicating the Appliance in accordance with at least one exemplary embodiment of the present invention; and an electronic marking (i.e. text, digital audio, digital video, etc) apparent during the normal operation of the target device indicating the Appliance in accordance with at least one exemplary embodiment of the present invention.

At least one exemplary embodiment includes a Communications port system is included for communicating with the central server system across a Communications network, the system further comprising: a Communications port system that is either: implemented by the Target Appliance as part of its normal functionality and shared with the present system, or; Implemented independently of the normal functionality of the Target Appliance by adding additional hardware during the manufacturing process (i.e. adding an integrated circuit and supporting hardware implementing Bluetooth Communications); and a appropriate Communications protocol.

At least one exemplary embodiment includes a Communications port system that implements Communications with the central server system through a intermediate system (i.e. through a personal computer connected to the Internet), the system further comprising: a method for interfacing with an intermediate system, such as a personal computer, that enables Communications with the central server system.

At least one exemplary embodiment includes a central server system supports various processes including a user interface system, a device registration process, a device password system, a missing or stolen device reporting process, and Communications, the system further comprising: a user interface system allowing end-users access to the processes of the central server system through two distinct interface methods: a website interface system with Internet security features familiar to those skilled in the art; a hotline telephone system with a call center, automated interactive voice prompts, or a combination of both; a device registration process; a missing or stolen device reporting process; a database system for storing information relating to at least one exemplary embodiment of the present invention including a plurality of device passwords, recognized MAC addresses, user login information, device information, and related data; a database management system for handling the storage and retrieval of information from the database system; a law enforcement interface system for notifying the appropriate authorities regarding missing or stolen Appliances and allowing law enforcement authorities access pertinent information from the database management system; and a Communications system for communicating with a plurality of Target Appliance Components.

At least one exemplary embodiment can include a registration process system, where the registration process further comprises: a method for soliciting personal information from the end-user including user name, login information, Target Appliance make/model, bill-of-sale information, payment information, various preferences, and other data; and a connection to the database management system for storing user data.

At least one exemplary embodiment includes a reporting process system, where the missing or stolen device reporting process further comprises: a verification system interfacing with the database management system for verifying the identify of a plurality of end-users; a method for generating and transmitting a trigger signal to missing or stolen Appliances over a Communications networks; and a method for generating and transmitting a warning message to missing or stolen Appliances over a Communications network.

At least one exemplary embodiment includes communication to a law enforcement interface system where the interface system enables the notification of appropriate authorities regarding missing or stolen Appliances and the interaction of law enforcement authorities with the database system of the central server, the system further comprising: a method for contacting the appropriate authorities and law enforcement agencies regarding missing or stolen Appliances; a method for tracking the physical location of missing or stolen Appliances through the Communications port of the Target Appliance Component; an interface system allowing law enforcement authorities to access certain pertinent information through the database management system, allowing authorities to: check recovered Appliances against the registered Appliances listed in the database system; and utilize a physical location tracking abilities related to a missing or stolen Target Appliance.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions of the relevant exemplary embodiments.

Thus, the description of the invention is merely exemplary in nature and, thus, variations that do not depart from the gist of the invention are intended to be within the scope of the exemplary embodiments of the present invention. Such variations are not to be regarded as a departure from the spirit and scope of the present invention.

What is claimed is:

1. An anti-theft method comprising:
determining whether a user's authorization parameters match stored verification parameters;
selecting a feature of a device to affect if the user's authorization parameters do not match the stored verification parameters; and
gradually affecting the selected feature of the device.

2. The method according to claim 1, where the user's authorization parameter is a written passcode.

3. The method according to claim 1, where the user's authorization parameter is a verbal passcode.

4. The method according to claim 1, where the user's authorization parameter is a biometric passcode.

5. The method according to claim 2, where the written passcode is a word or phrase.

6. The method according to claim 3, where the verbal passcode is a spoken word or phrase.

7. The method according to claim 4, where the biometric passcode is at least one of the following:
an earprint;
a fingerprint; and
an eyeprint.

8. The method according to claim 7, where the earprint is a plot of the frequency response of an ear that an earpiece is in, where the earpiece sends a signal to the ear it is in and measures the frequency response of the ear, and compares the measured frequency response to an authorized frequency response.

9. The method according to claim 7, where the eyeprint is a retina scan.

10. The method according to claim 1, where the feature is at least one of the following:
the volume of the device;
the power on time of the device;
the visual display of the device; and
the audio transmitted by the device.

11. The method according to claim 1, where the step of gradually affecting the selected feature reduces the volume of a device from its current volume setting at the time of not matching to no volume over a period of time, where an incremental decrease in volume is applied each hour, where the incremental decrease is equal to the period of time divided by the number of hours in the period of time, with any remainder applied in the last hour.

12. The method according to claim 1, where the step of gradually affecting the selected feature reduces the intensity of a display of a device from an initial intensity setting at the time of not matching to no intensity over a period of time, where an incremental decrease in intensity is applied each hour, where the incremental decrease is equal to the period of time divided by the number of hours in the period of time, with any remainder applied in the last hour.

13. The method according to claim 1, where the step of gradually affecting the selected feature reduces the color of a display of a device from an initial intensity setting at the time of not matching to black and white over a period of time, where an incremental decrease in color is applied each hour, where the incremental decrease is equal to the period of time divided by the number of hours in the period of time, with any remainder applied in the last hour.

14. The method according to claim 1, where the step of gradually affecting the selected feature reduces the power on time of a device from an initial power on time value at the time of not matching to no power on over a period of time, where an incremental decrease in the power on time is applied each hour, where the incremental decrease is equal to the period of time divided by the number of hours in the period of time, with any remainder applied in the last hour.

15. The method according to claim 1, where the step of gradually affecting the selected feature reduces a signal to noise value of audio content transmitted by the device from an initial signal to noise value at the time of not matching to a signal to noise value where the noise intensity is greater than the audio content intensity over a period of time, where an incremental decrease in signal to noise value applied each hour, where the incremental decrease is equal to the period of time divided by the number of hours in the period of time, with any remainder applied in the last hour.

16. the method according to claim 15, where the signal to noise value is the signal to noise ratio.
